(19) United States
(12) Patent Application Publication
(10) Pub. No.: US 2012/0029997 A1
(43) Pub. Date: Feb. 2, 2012

(54) METHODS, SYSTEMS, AND COMPUTER READABLE MEDIA FOR REGISTERING IN A MERCHANT SPONSORED PROGRAM USING A NEAR FIELD COMMUNICATION (NFC) DEVICE

(76) Inventors: Mohammad Khan, San Jose, CA (US); Pradeep Kumar, Fremont, CA (US); Kaushik Roy, Foster City, CA (US)

(21) Appl. No.: 13/170,903

(22) Filed: Jun. 28, 2011

Related U.S. Application Data
(60) Provisional application No. 61/359,120, filed on Jun. 28, 2010.

(51) Int. Cl. G06Q 30/02; H04B 5/00

(52) U.S. Cl. 705/14.27; 455/41.1

(57) ABSTRACT

Methods, systems, and computer readable media for registering in a merchant sponsored program using a near field communication (NFC) device is disclosed. In one embodiment, the method includes interfacing an NFC enabled mobile device with a smart poster associated with a merchant sponsored program to obtain a merchant sponsored program identifier from the smart poster, and receiving, at a merchant backend server, a request message for merchant sponsored program registration information from the NFC enabled mobile device, wherein the request message from the NFC enabled device includes the merchant sponsored program identifier. The method further includes obtaining merchant sponsored program registration information associated with the merchant sponsored program using the merchant sponsored program identifier and providing the merchant sponsored program registration information to the NFC enabled mobile device.

### RELATED APPLICATIONS

The present application claims the benefit of U.S. Provisional Patent Application Ser. No. 61/359,120, filed Jun. 28, 2010, the disclosure of which is incorporated herein by reference in its entirety.

### TECHNICAL FIELD

The subject matter described herein relates to wireless smart devices. More particularly, the subject matter described herein relates to methods, systems, and computer readable media for registering in a merchant sponsored program using a near field communication (NFC) device.

### BACKGROUND

At present, sign-up processes for retailer sponsored loyalty and promotion programs or retailer payment programs can be time-consuming and intrusive. The sign up process may make requests for more personal information, such as name and home address, which users are hesitant to provide. These sign-up processes can vary from filling out a paper application to entering information online via a merchant web site. After signing up, the users are typically provided with a plastic card or are told that a plastic card will be sent to them via the mail. Thus, in addition to the inconvenience involved with the manual sign-up process, the user is now provided with yet another plastic card to be stored in an already crowded billfold or purse.

Accordingly, there exists a need for methods, systems, and computer readable media for registering in a merchant sponsored program using a near field communication (NFC) device.

### SUMMARY

According to one aspect, the subject matter described herein includes Methods, systems, and computer readable media for registering in a merchant sponsored program using a near field communication (NFC) device is disclosed. In one embodiment, the method includes interfacing an NFC enabled mobile device with a smart poster associated with a merchant sponsored program to obtain a merchant sponsored program identifier from the smart poster, and receiving, at a merchant backend server, a request message for merchant sponsored program registration information from the NFC enabled mobile device, wherein the request message from the NFC enabled device includes the merchant sponsored program identifier. The method further includes obtaining merchant sponsored program registration information associated with the merchant sponsored program using the merchant sponsored program identifier and providing the merchant sponsored program registration information to the NFC enabled mobile device.

As used herein, the terms “wireless smart device”, “NFC device”, and “NFC enabled device” may be synonymous and are intended to refer to any device with NFC, radio frequency (RF) communication, or barcode capturing capabilities to interact with a smart poster with the corresponding technology. In near field communication, a wireless smart device may communicate with a passive wireless transceiver, or smart tag, located on or in the smart poster via inductive coupling of the smart tag antenna to the NFC device antenna. The two or more loop antennas effectively form a transformer. The smart tag amplitude-modulates the RF field to send information to the device. The device communicates with the transceiver and/or reader by modulating the loading on the device antenna, which also modulates the load on the reader antenna. As used herein, the term “wireless communications” includes communications conducted at ISO 14443 and ISO 18092 interfaces. These specifications define communication protocols for wireless smart devices operating in close proximity with a reader antenna.

The subject matter described herein may be implemented in software, in combination with hardware and/or hardware and firmware. For example, the subject matter described herein may be implemented in software executed by a hardware based processor. In one exemplary implementation, the subject matter described herein for registering in a merchant sponsored program using a NFC device may be implemented using a non-transitory computer readable medium to having stored thereon executable instructions that when executed by the hardware processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a schematic diagram illustrating an exemplary system for registering in a merchant sponsored program using a near field communication (NFC) device according to an embodiment of the subject matter described herein; and

FIG. 2 is a flow chart illustrating an exemplary process for registering in a merchant sponsored program using a near field communication (NFC) device according to an embodiment of the subject matter described herein.

### DETAILED DESCRIPTION

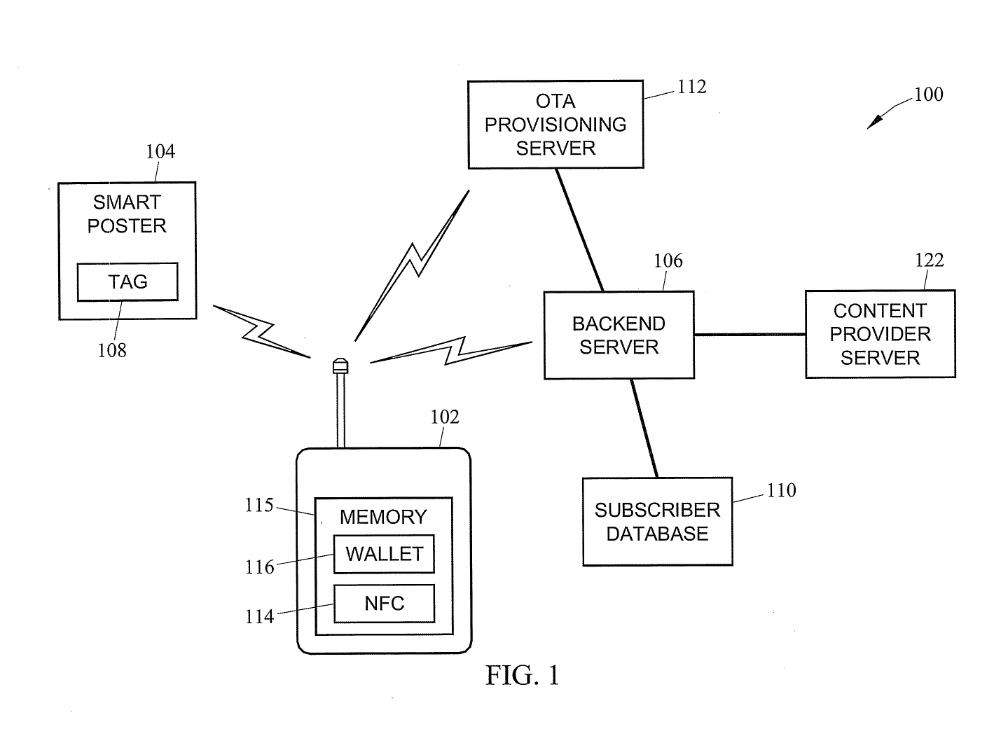

The present subject matter describes various methods, systems, and computer readable media that may be utilized to facilitate the use of a wireless smart device to register for a merchant sponsored program without the use of a sales agent and/or paper application. As used herein, the term “merchant” includes any entity that provides any good, service, membership, or information with or without a profit. Exemplary merchants include restaurants, public transportation systems, retail establishments, movie cinemas, and the like. The present subject matter may provide a consumer/user the opportunity to register for a merchant sponsored program, such as a retailer loyalty program, retailer promotion program, or retailer payment program (e.g., a merchant sponsored credit card program), by receiving data downloaded from a smart poster via a near field communication (NFC) tap. Merchant sponsored program registration data may also be communicated using any wireless means of communication, such as 4G, 3G, GSM, GPRS, WiFi, WiMax, and other remote local or remote wireless communication using information obtained via the interfacing of a wireless NFC enabled mobile device to a smart poster. In one embodiment, consumers may conveniently register in a merchant's sponsored program in a manner that bypasses or eliminates the need for interaction with a sales clerk. FIG. 1 is a block diagram depicting an exemplary system 100 for registering in a merchant sponsored program using a near field communication (NFC) device according to an embodiment described herein. Although the following description describes registering for a merchant loyalty program, system 100 may also be used to facilitate the registration in other merchant sponsored programs (such as a retailer promotion program or retailer payment program) without departing from the scope of the present subject matter. Referring to FIG. 1, exemplary system 100 includes a wireless smart device such as an NFC enabled mobile device 102 or smart phone, a smart poster 104, merchant backend server 106 also known as a loyalty program registration system for conducting in-store or near-store loyalty program registration through using NFC device 102. Although a single backend server 106 is shown in FIG. 1 to be connected to a single content provider server 122, network architecture utilizing additional backend servers (e.g., an mTrigger Manager server and an mContent Manager server produced by ViVOtech, Inc.) and additional content provider servers may be employed without departing from the scope of the present subject matter.

Smart poster 104 may include any suitable two or three dimensional object (e.g., a promotional cardboard cut-out/stand equipped with a smart NFC enabled tag, or “smart tag”) that can be placed in any public place and accessed by potential consumers or purchasers of goods and/or services. Smart poster 104 may be located inside and/or near a retail establishment and displays an advertisement of the merchant's loyalty program. For example, smart poster 104 may be located inside a coffee shop or fast food restaurant and contain loyalty program registration data accessible to NFC device 102 via an NFC tap (or any other interfacing). Thus, smart poster 104 is able to facilitate convenient retailer loyalty program registration and thereby allows consumers the option to avoid filling out a paper application and/or waiting for a sales clerk to process the application and to issue a physical loyalty program card. In another embodiment, a smart poster 104 may be located at a mall kiosk or common area near a retail establishment or store location.

In one embodiment, NFC device 102 may obtain or receive an identifier (e.g., a binary, a numeric, or an alphanumeric code) regarding a merchant loyalty program from smart poster 104 when interfaced via a single NFC tap. Smart poster 104 may include a mechanism, such as smart tag 108 (e.g., a passive wireless transceiver) for wirelessly communicating with NFC enabled device 102 via a single NFC tap, and allowing NFC enabled device 102 to obtain smart tag content information associated with loyalty program registration information. The smart tag content information may include a merchant sponsored program identifier, a content provider code (CLC), a tag location code (TLC), and a location identifier (e.g., an IP address, a URL, a URI, and the like) associated with a merchant backend server 106. In one embodiment, the location identifier includes address/location information that may be used to direct the NFC enabled device to contact backend server 106.

In one embodiment, smart tag 108 includes a passive NFC or RF tag device that is powered by an interfacing NFC enabled device 102. For example, after NFC device 102 is tapped or brought in close proximity with smart tag 108, smart tag 108 may be activated by obtaining power from the electromagnetic field generated by NFC enabled device 102. In other embodiments, smart tag 108 may include an active RF tag or reader equipped with its own power source. Whether passive or active, smart tag 108 is capable of communicating the aforementioned smart tag content information to NFC device 102 when NFC device 102 interfaces with smart tag 108.

In an alternate embodiment, NFC enabled device 102 may also receive merchant loyalty program and location information regarding the merchant loyalty program via interfacing with a barcode (not shown) included on smart poster. NFC device 102 may include a camera that is used to scan or capture the barcode on smart poster 104. The barcode may include a location identifier associated to merchant backend server 106, which may be configured to provide registration information regarding a particular merchant loyalty program. An application on NFC device 102 may read the barcode captured by the camera and extract the encoded information for directing the NFC device 102 to merchant backend server 106. For example, such an application may be configured to read barcodes from jpeg or other image data captured by the camera. The barcode may direct NFC device 102 to the location of merchant backend server 106 using, for example, a URL, an IP address, or the like.

After receiving the smart tag content data from smart tag 108, NFC enabled device 102 may be configured to automatically communicate with merchant backend server 106. In one embodiment, a wallet application 116 in device 102 is configured to contact a backend server 106 using the location identifier to send a message or signal requesting merchant loyalty program registration data. The request message may include one or more of: the location identifier, the merchant sponsored program identifier (e.g., a merchant loyalty program identifier), and a subscriber identifier (e.g., the phone number of NFC device 102). In one embodiment, NFC device 102 may initiate wallet application 116 upon interfacing with smart poster 104 (e.g., in one embodiment, wallet application 116 may be triggered upon receiving smart tag data). Wallet application 116 may use the URL, IP address, or location identifier to communicate with merchant backend server 106. In one embodiment, wallet application 116, NFC module 114, and a web browser (not shown) may reside in a memory element 115 of NFC device 102. Wallet application 116 may be stored in a secure memory element of NFC device 102 or in a non-secure baseband memory without departing from the scope of the present subject matter. Wallet application 116 may include a software application (e.g., a midlet or smart card web server applications) that when executed by a hardware processor in NFC device 102 manages multiple softcards stored on the mobile device, such as credit cards, debit cards, electronic loyalty cards, electronic loyalty reward certificates, electronic coupons, electronic tickets, and the like. Electronic payment softcards including credit or debit cards may be stored in any suitable priority or within wallet application 116. NFC module 114 may be a software application that when executed by a hardware processor that allows NFC device 102 to communicate via NFC. In an alternate embodiment, NFC module may be embodied as a hardware based circuit configured to facilitate NFC communications.

Upon receiving the request message, merchant backend server 106 may be configured to locate loyalty program registration data using the loyalty program identifier. In one embodiment, the registration data may be stored locally in a database or memory. Alternatively, the registration data may be located external to the merchant backend server 106, such as content provider server 122 or in some other external database or storage server. In such a scenario, backend server 106 may use a content provider code or the like to determine the address or location of content provider server 122. For example, backend server 106 may use the loyalty program identifier to access a database that maps merchant sponsored program identifiers to merchant loyalty program registration content provider servers. In one embodiment, the merchant backend server 106 may then use the mapped information to locate the appropriate content provider server 122. The CPC originally provided by smart poster 104 may also be used by backend server 106 to locate the appropriate content provider server.

After locating content provider server 122, merchant backend server 106 may send a request to server 122 for the desired loyalty program registration data. In response, content provider server 122 may forward the loyalty program registration data to backend server 106. Merchant backend server 106 may be configured to then forward the data back to NFC mobile device via an OTA provisioning server 112. In an alternate embodiment, content provider server 122 may be configured to forward the loyalty program registration data to OTA provisioning server instead of to merchant backend server 106.

OTA provisioning server 112 may be configured to receive loyalty program registration data and the subscriber identifier from backend server 106 (or, alternatively, content provider server 122). Using the subscriber identifier associated with NFC enabled device 102, OTA provisioning server 112 may effectively utilize (i.e., communicate with) an OTA provisioning software client (not shown) provisioned on device 102 to transmit the registration content securely over the air to device 102. The registration data may be stored in either baseband memory (unsecured) or in a secure element of device 102 based on the level of security of the registration data. Security levels may be set by the owner of the merchant loyalty and promotional content. Upon receiving the program registration data, NFC enabled device 102 may be configured to present the registration data (e.g., terms and conditions) to a user via a screen display on device 102.

If the terms and conditions associated with the loyalty program are agreeable, the user may use device 102 to send a confirmation message or signal to backend server 106. In one embodiment, the user may confirm interest in a merchant sponsored program by providing the mobile phone number of device 102 to backend server 106 in order to complete the registration process. In response, backend server 106 may process the confirmation and subsequently notify NFC device 102 that the registration process is complete (e.g., via an SMS message). Backend server 106 may then also store the subscriber identifier (i.e., the mobile phone number) in a merchant sponsored program subscriber database 110. Upon a successful registration, backend server 106 may be configured to provide an electronic merchant sponsored program softcard (e.g., an electronic retailer loyalty softcard) and/or other promotional content to device 102 via OTA provisioning server 112. In one embodiment, OTA provisioning server 112 may be configured to provide an electronic merchant sponsored program softcard to NFC device 102 without backend server 106 receiving a confirmation message (e.g., server 106 instructs OTA provisioning server 112 to provide a softcard to device 102 upon receiving the request for registration data from NFC device 102). In both of the aforementioned scenarios (i.e., OTA provisioning server providing a softcard with or without backend server 106 receiving confirmation of registration from the NFC device), OTA provisioning server 112 may provide the softcard along with an associated loyalty account number, an image of the loyalty card, and any other support information/data.

In one embodiment, upon completing the loyalty program registration process, server 106 may provide device 102 with the retailer's web site information (e.g., an web site link) should the user of device 102 require additional information or to provide more personal information (e.g., name, address, etc.) at the user's choice and/or convenience. The additional information may also be ultimately stored in subscriber database 110.

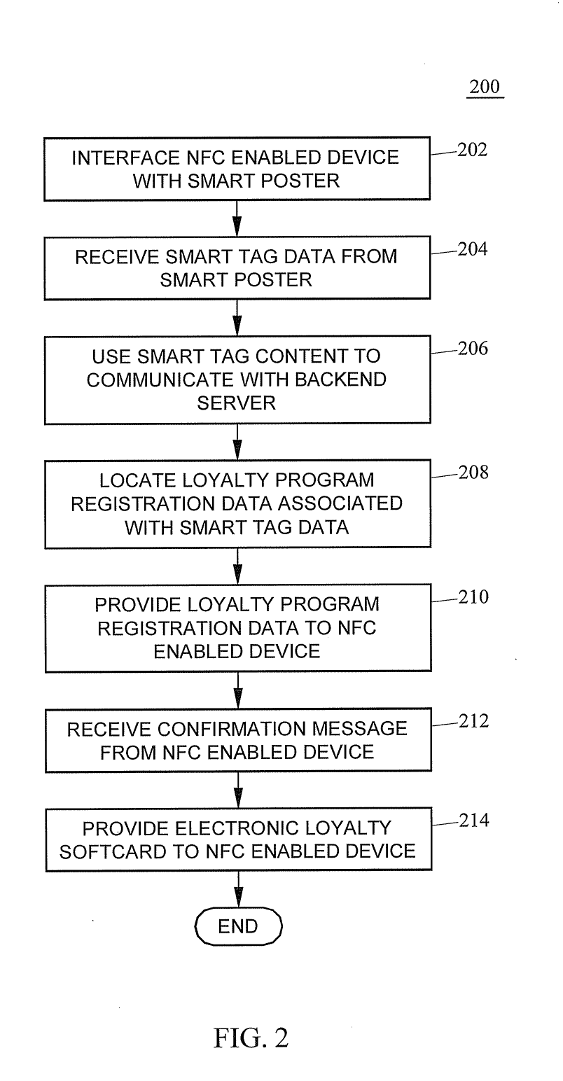

FIG. 2 is a flow chart illustrating an exemplary method 200 for registering in a merchant sponsored program using a near field communication (NFC) device according to an embodiment of the subject matter described herein. Although method 200 describes a process for registering for a merchant loyalty program, method 200 may also be used to facilitate the registration in other merchant sponsored programs (such as a retailer promotion program or retailer payment program) without departing from the scope of the present subject matter.

In block 202, NFC device 102 is interfaced with smart poster 104. Smart poster may be located in an area accessible by a potential consumer of a good or service is provided. Smart poster 104 may be disposed within and/or near a merchant establishment and may display a retailer sponsored loyalty or promotion program. Upon interfacing NFC device 102 with smart poster 104, NFC device 102 may be directed to access a merchant backend server specific to the merchant loyalty program advertised by the smart poster.

In block 204, NFC device 102 receives smart tag content data from smart poster 104. In one embodiment, mobile device 102 may receive a merchant loyalty program identifier and a location identifier associated with a merchant backend server in a wireless manner (e.g., via NFC). In one embodiment, the smart tag information includes at least one of a merchant loyalty registration identifier, a content provider code (CPC), a location identifier (e.g., an IP address, a URL, a URI, and the like) associated with a backend server 106, and a tag location code (TLC).

In block 206, at least a portion of the smart tag content data is used to communicate with a merchant backend server. In one embodiment, wallet application 116 uses the location identifier, such as an IP address, to contact merchant backend server 106. For example, wallet application 116 may be configured to use an IP addresses provided by smart poster 104 to address and send a request message to merchant backend server 106. The request message may include the phone number associated with the sending mobile device 102, a merchant loyalty program identifier that identifies a particular loyalty program and a CPC that identifies a content provider server that contains the registration data associated with the loyalty program. Notably, merchant backend server 106 may contain a database that maps CPCs with addresses associated with a plurality of content provider servers.

In block 208, loyalty program registration data associated with the smart tag data is located. In one embodiment, merchant backend server 106 may use the merchant loyalty program identifier and/or CLC to locate a content provider server 122 that contains the merchant loyalty program registration data requested by the NFC enabled device 102.

In block 210, loyalty program registration data is provided to the NFC enabled device. After the merchant loyalty program registration data is located at content provider server 122, merchant backend server 106 may be configured to obtain the registration data and provide the registration data to NFC enabled device 102. In one embodiment, merchant backend server 106 may use the subscriber identifier (e.g., the phone number) associated with the receiving NFC enabled device 102, which was previously included in the registration data request message, to direct the registration data to the requesting NFC enabled mobile device 102.

In block 212, a confirmation message is received from NFC enabled device. After being received by NFC enabled mobile device 102, the loyalty program registration data may be processed. In one embodiment, NFC enabled device 102 processes the received registration data and subsequently displays the features, benefits, and terms and conditions of the merchant loyalty program to a user of the NFC enabled device 102. After reviewing and agreeing to the terms and conditions of the merchant loyalty program, a user may then instruct (e.g., via a user interface) NFC enabled device 102 to send a confirmation message or indication/signal to merchant backend server 106. In one embodiment, the confirmation message may include the phone number associated with NFC enabled device 102. Once the confirmation message to participate in loyalty program is received, merchant backend server may enroll the loyalty customer into the loyalty program (e.g., storing the subscriber phone number in database 110).

In block 214, an electronic loyalty softcard is provided to NFC enabled mobile device. Once the loyalty customer is registered in the retailer loyalty program, merchant backend server 106 may provide electronic loyalty softcard data (e.g., from content provider server 122) associated with the retailer loyalty program to OTA provisioning server 112 and instruct server 112 to transmit a loyalty program softcard (i.e., a software based electronic card that can be displayed via a phone screen) to NFC enabled device 102.

The present subject matter has a number of advantages over present day registration procedures. First, the registration process is non-intrusive since the only information the user is asked for is a mobile phone number. Notably, the user does not have to provide name, address and any other information. At a later point, when the user is satisfied with the program, the user may choose to provide further information via the retailer's online website. Second, the registration process is paperless. Since there is no paperwork involved in this process, the registration process dramatically reduces the total time involved in the completing the sign-up process. It also eliminates data entry errors involved with paperwork. Lastly, the present subject matter does not require involvement of personnel from the retailer thereby reducing the sign-up cost for the retailer.

It is understood that various details of the presently disclosed subject matter may be changed without departing from the scope of the presently disclosed subject matter. Furthermore, the foregoing description is for the purpose of illustration only, and not for the purpose of limitation.

What is claimed is:

1. A system for registering in a merchant sponsored program using a near field communication (NFC) device, the system comprising:
a smart poster associated with a merchant sponsored program configured for providing a merchant sponsored program identifier when interfaced with an NFC enabled mobile device; and
a merchant backend server for receiving a request message for merchant sponsored program registration information from the NFC enabled mobile device, wherein the request message from the NFC enabled device includes the merchant sponsored program identifier, for obtaining merchant sponsored program registration information associated with the merchant sponsored program using the merchant sponsored program identifier, and for providing the merchant sponsored program registration information to the NFC enabled mobile device.

2. The system of claim 1 wherein the merchant sponsored program includes at least one of: a retailer loyalty program, a retailer promotion program, and a retailer payment program.

3. The system of claim 1 wherein the merchant backend server is configured to provide the merchant sponsored program registration information to the NFC enabled device via an over the air (OTA) provisioning server.

4. The system of claim 1 wherein the NFC enabled mobile device receives the merchant sponsored registration identifier via NFC by tapping the smart poster.

5. The system of claim 1 wherein at least one of: a tag location code (TLC), a content provider code (CPC), and an Internet protocol (IP) address is obtained with the merchant sponsored program identifier from the smart poster.

6. The system of claim 5 wherein the IP address is associated with the merchant backend server.

7. The system of claim 1 wherein the merchant backend server is configured to receive a request message that includes a subscriber identifier and the merchant sponsored program identifier.

8. The system of claim 1 wherein the merchant sponsored program registration information enables the NFC enabled mobile device to display terms and conditions of the merchant sponsored program.

9. The system of claim 1 wherein the merchant backend server is configured to receive a confirmation message from the NFC enabled mobile device, wherein the confirmation message registers a user associated with the NFC enabled mobile device into the merchant sponsored program.

10. The system of claim 9 wherein the merchant backend server is configured to instruct an over the air (OTA) provisioning server to provide an electronic merchant sponsored program softcard to the NFC enabled mobile device upon receiving the confirmation message.

11. A method for registering in a merchant sponsored program using a near field communication (NFC) device, the method comprising:
interfacing an NFC enabled mobile device with a smart poster associated with a merchant sponsored program to obtain a merchant sponsored program identifier from the smart poster;
receiving, at a merchant backend server, a request message for merchant sponsored program registration information from the NFC enabled mobile device, wherein the request message from the NFC enabled device includes the merchant sponsored program identifier;
obtaining merchant sponsored program registration information associated with the merchant sponsored program using the merchant sponsored program identifier; and
providing the merchant sponsored program registration information to the NFC enabled mobile device.

12. The method of claim 11 wherein the merchant sponsored program includes at least one of a retailer loyalty program or a retailer promotion program.

13. The method of claim 11 wherein providing the merchant sponsored program registration information includes providing the merchant sponsored program registration information to the NFC enabled device via an over the air (OTA) provisioning server.

14. The method of claim 11 wherein interfacing the NFC enabled mobile device with the smart poster includes tapping the NFC enabled mobile device with the smart poster.

15. The method of claim 11 wherein at least one of: a tag location code (TLC), a content provider code (CPC), and an Internet protocol (IP) address is obtained with the merchant sponsored program identifier from the smart poster.

16. The method of claim 15 wherein the IP address is associated with the merchant backend server.

17. The method of claim 11 wherein receiving a request message includes receiving a request message that includes a subscriber identifier and the merchant sponsored program identifier.

18. The method of claim 11 wherein the merchant sponsored program registration information enables the NFC enabled mobile device to display terms and conditions of the merchant sponsored program.

19. The method of claim 11 comprising receiving, at the merchant backend server, a confirmation message from the NFC enabled mobile device, wherein the confirmation message registers a user associated with the NFC enabled mobile device into the merchant sponsored program.

20. The method of claim 19 comprising instructing an over the air (OTA) provisioning server to provide an electronic merchant sponsored program softcard to the NFC enabled mobile device upon receiving the confirmation message.

21. A non-transitory computer readable medium having stored thereon comprising computer executable instructions that when executed by a processor of a computer performs steps comprising:
interfacing an NFC enabled mobile device with a smart poster associated with a merchant sponsored program to obtain a merchant sponsored program identifier from the smart poster;
receiving, at a merchant backend server, a request message for merchant sponsored program registration information from the NFC enabled mobile device, wherein the request message from the NFC enabled device includes the merchant sponsored program identifier;
obtaining merchant sponsored program registration information associated with the merchant sponsored program using the merchant sponsored program identifier; and
providing the merchant sponsored program registration information to the NFC enabled mobile device.
